(19) United States
(12) Patent Application Publication
(10) Pub. No.: US 2025/0326079 A1
(43) Pub. Date: Oct. 23, 2025

(54) Handheld work apparatus

(71) Applicant: Andreas Stihl AG & Co. KG, Waiblingen (DE)

(72) Inventors: Denis Ehrler, Wernau (DE); Johannes Gültlinger, Ludwigsburg (DE); Patrick Schindler, Weilheim an der Teck (DE); Johann-Sebastian Renz, Gomaringen (DE)

(73) Assignee: Andreas Stihl AG & Co. KG, Waiblingen (DE)

(21) Appl. No.: 19/184,010

(22) Filed: Apr. 21, 2025

(30) Foreign Application Priority Data
Apr. 23, 2024 (DE) 102024111417.7

(51) Int. Cl. B23Q 11/08; B23D 45/16

(52) U.S. Cl. CPC B23Q 11/08; B23D 45/16

(57) ABSTRACT

A handheld work apparatus includes: a housing (2); a motor support unit (10) which is separate from the housing (2) and is connected to the housing (2); a drive motor (3) arranged in the housing (2) for driving a tool (5) that rotates about an axis of rotation (8), wherein the drive motor (3) is attached to the motor support unit (10); a protective hood (51), the protective hood (51) at least partially covering the tool (5) and a stop (110) being provided on the protective hood (51). A mating stop (120) is formed on the motor support unit (10), in particular directly, which is provided for operative connection with the stop (110) of the protective hood (51) in order to restrict the pivoting movement of the protective hood (51) to an end position (131).

### CROSS-REFERENCE TO RELATED APPLICATION

This application claims the benefit of German Patent Application DE 102024111417.7, filed on Apr. 23, 2024, the content of which is incorporated in its entirety.

### TECHNICAL FIELD

The disclosure relates to a handheld work apparatus.

### BACKGROUND

A handheld work apparatus, in particular a cut-off machine, is known, which comprises a housing and a motor support unit which is separate from the housing, wherein the motor support unit is connected to the housing. Furthermore, such a work apparatus comprises a drive motor arranged in the housing for driving a cutting wheel that rotates about an axis of rotation. The drive motor is attached to the motor support unit. The cutting wheel is partially covered by a protective hood.

A standard requirement for such a work apparatus is, among others, a so-called burst test. In a burst test, a scenario is presented in which the cutting wheel breaks into multiple parts during operation of the work apparatus, which are then caught by the protective hood. Standards stipulate that the protective hood absorbs the kinetic energy of the cutting wheel parts, but the freedom of movement of the protective hood is limited.

### SUMMARY

It is an object of the disclosure to specify a handheld work apparatus, which, via the protective hood, reliably absorbs the kinetic energy of cutting wheel parts that get into the protective hood and which reliably dissipates the kinetic energy of the protective hood.

This object is solved by a handheld work apparatus as disclosed and claimed.

The work apparatus comprises a housing; a motor support unit which is separate from the housing and is connected to the housing; a drive motor arranged in the housing for driving a tool that rotates about an axis of rotation, the drive motor being attached to the motor support unit; a protective hood, the protective hood at least partially covering the tool, with a stop being provided on the protective hood, wherein a mating stop is formed on the motor support unit which is provided for operative connection with the stop of the protective hood in order to restrict the pivoting movement of the protective hood to an end position. The mating stop is formed on the motor support unit, in particular directly.

The motor support unit of the handheld work apparatus is a component with particularly high strength and rigidity. This ensures that the drive motor attached to the motor support unit has sufficient concentricity. By forming the mating stop on the motor support unit, it can be ensured that large forces and torques can be transferred from the protective hood to the motor support unit via the stop and the mating stop. By forming the mating stop on the motor support unit, the kinetic energy of the parts of the tool that are captured in the protective hood, in particular the parts of the cutting wheel, can be transferred to the motor support unit.

It is provided in particular that the protective hood is mounted so as to pivot about the axis of rotation of the tool and that the maximum pivot angle of the protective hood when pivoted from the end position to the open position of the protective hood is less than or equal to 90°, in particular less than 60°. In the end position of the protective hood, the stop of the protective hood and the mating stop on the motor support unit come into contact. If the protective hood pivots when the tool ruptures, it is stopped in its end position by the interaction between stop and mating stop. The movement of the protective hood from the open position to the end position is blocked by the stop and mating stop from going beyond the end position. The maximum pivot angle of the protective hood when pivoted from the end position to the open position of the protective hood is in particular at least 30°.

It is provided in particular that the mating stop is integral with the motor support unit. The mating stop and the motor support unit therefore form just one component. The motor support unit is designed in particular as a cast component. The motor support unit preferably consists of a metal alloy, in particular of a magnesium alloy. Thus, a high component strength can be achieved.

It is advantageously provided that the mating stop has a load transfer structure. The load transfer structure extends in particular starting from a stop surface tangential to the direction of rotation of the tool into a base body of the motor support unit. Thus, in the event of the stop and mating stop colliding, the forces can be transferred in their direction of action to the motor support unit via the load transfer structure. The flow of force is therefore not deflected, but rather is directed over the shortest distance from the stop surface of the mating stop to the motor support unit. As a result, the mating stop can absorb large forces.

It is provided in particular that the protective hood consists of a metal alloy, wherein the stop is cast onto the protective hood. Designing the protective hood and stop as a single piece means that a high component strength can be achieved, which makes it possible to transfer large forces and torques from the protective hood via the stop and the mating stop to the motor support unit.

Preferably, the work apparatus has a first stop surface formed on the stop of the protective hood and a second stop surface formed on the mating stop, wherein, when the stop and mating stop make contact, the first stop surface and the second stop surface touch each other in a common contact surface. The first stop surface and the second stop surface are designed in such a way that their surfaces make full contact when they come into mutual contact. The surface pressure on the stop surfaces can thus be kept as low as possible to stop the components from getting damaged. It is in particular provided that the contact surface spans a contact plane, and that the contact plane intersects the tool at a contact line on a tool circumference of the tool and makes an angle with a tangent plane of the tool that touches the tool at the contact line. This angle is open in the direction of rotation of the tool. The angle is in particular less than or equal to 90°, in particular less than 80°. As a result, the stop and the mating stop interlock. In other words, the stop and the mating stop are hooked together. It can thus be ensured that the stop on the protective hood cannot slide off the mating stop on the motor support unit. The movement of the protective hood can thus be stopped reliably. The angle is in particular more than 55°, in particular more than 65°, in particular more than 70°. This ensures that the wedge effect that occurs, i.e. the force components that are aligned vertical to the surface normal of the contact surface, do not become too large and damage the stop or the mating stop. Moreover, notch effects may also occur due to an angle that is too acute. Particularly advantageously, the contact surface is parallel to a plane which is spanned by the longitudinal centre axis of the arm and by an axis of rotation of the tool.

It is provided in particular that, in the direction of the axis of rotation of the tool, the mating stop is wider than the stop. In the event that the tool ruptures, the protective hood can also deform and/or swing in the direction of the axis of rotation of the tool when capturing the individual tool fragments. Consequently, the position of the protective hood can change in a direction perpendicular to the tool plane. The wide design of the mating stop nevertheless ensures that the entire first contact surface of the stop comes into contact with the second stop surface on the mating stop even if its position changes in the direction of the axis of rotation of the tool. Thus, even in the event of rupture, it can be ensured that force is transmitted optimally between the stop and the mating stop.

### BRIEF DESCRIPTION OF THE DRAWINGS

Exemplary embodiments of the invention are explained hereinafter with reference to the drawing.

FIG. 1 shows, in a perspective illustration, an embodiment of the handheld work apparatus.

FIG. 2 shows, in a side view, the handheld work apparatus according to FIG. 1.

FIG. 3 shows, in a side view, the handheld work apparatus according to FIG. 1 without a tool and in part without a cover of the arm.

FIG. 4 shows, in a cutaway side illustration, the arm of the work apparatus according to FIG. 1 with pulley and belt.

FIG. 5 shows, viewed from above, a sectional illustration of the work apparatus according to FIG. 1,

FIG. 6 shows, viewed from above, a sectional illustration of the work apparatus according to FIG. 1 along the points of attachment of the housing to the motor support unit.

FIG. 7 shows, viewed from the rear, a sectional illustration of the work apparatus according to FIG. 1.

FIG. 8 shows, in a perspective illustration from the rear, the motor support unit of the work apparatus according to FIG. 1.

FIG. 9 shows, in a perspective illustration from the front, the motor support unit of the work apparatus according to FIG. 1.

FIG. 10 shows, in a plan view, the motor support unit of the work apparatus according to FIG. 1.

FIG. 11 shows, in a view from below, the motor support unit of the work apparatus according to FIG. 1.

FIG. 12 shows, in a lateral, perspective illustration, the work apparatus according to FIG. 1 in the open position of the protective hood.

FIG. 13 shows, in a lateral, perspective illustration, the work apparatus according to FIG. 1 in the end position of the protective hood.

FIG. 14 shows, in a side illustration, the work apparatus according to FIG. 1 with schematically illustrated protective hood in the open position and end position.

FIG. 15 shows, in an illustration from below, the work apparatus according to FIG. 1.

FIG. 16 shows, in a lateral, enlarged illustration, the stop and mating stop of the work apparatus according to FIG. 1 in contact.

FIG. 17 shows, in a perspective illustration, an alternative embodiment of the motor support unit with operating stop.

FIG. 18 shows, in a front view, the motor support unit according to FIG. 17.

FIG. 19 shows, in a cutaway sectional illustration along the section line between the arrows XIX, the motor support unit according to FIG. 18.

FIG. 20 shows, in a perspective illustration, a further alternative embodiment of the motor support unit with operating stop.

FIG. 21 shows, in a front view, the motor support unit according to FIG. 20, and

FIG. 22 shows, in a cutaway sectional illustration along the section line between the arrows XXII, the motor support unit according to FIG. 21.

### DETAILED DESCRIPTION

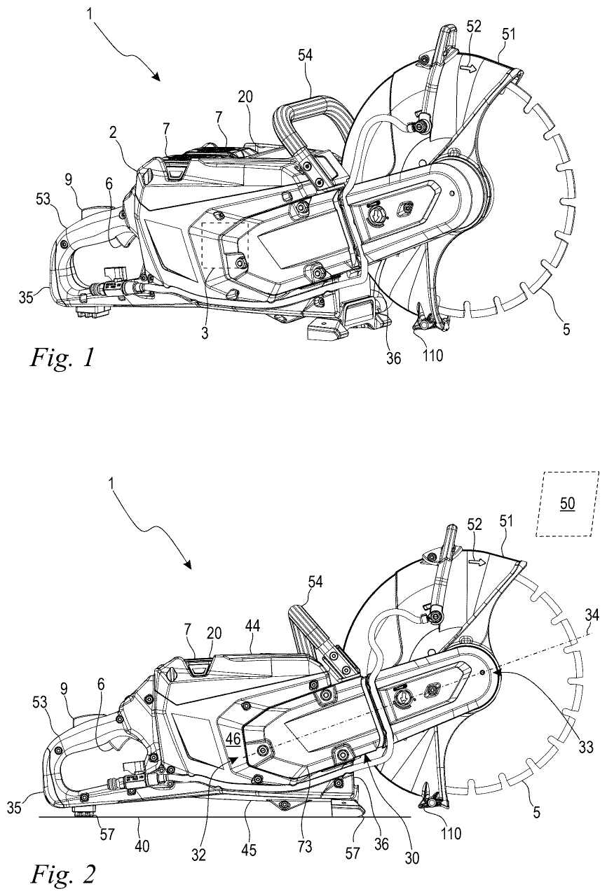

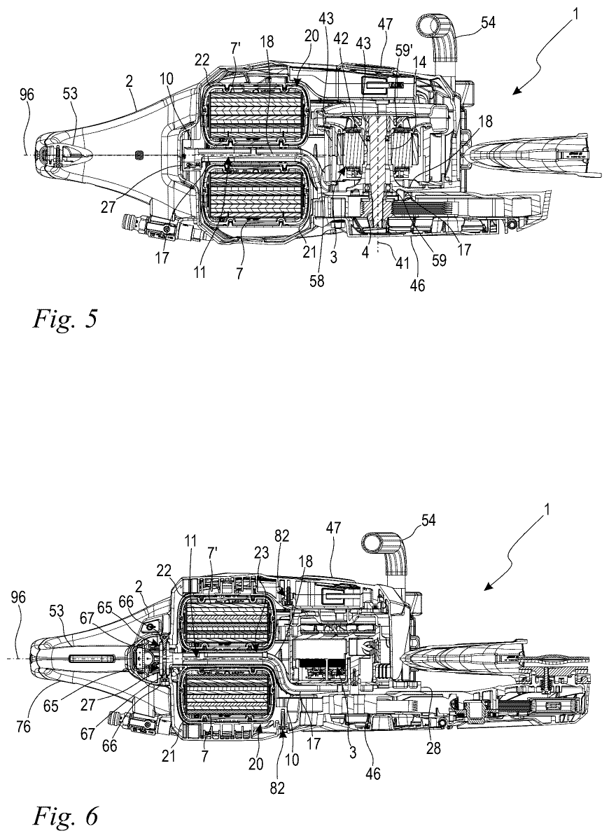

FIG. 1 shows an exemplary embodiment of the handheld work apparatus 1 as a cut-off machine. The work apparatus 1 can alternatively also be designed as a chainsaw or as another work apparatus. The work apparatus 1 is handheld, in particular hand-carried. The work apparatus 1 is carried and controlled by the operator during operation. The work apparatus 1 has a housing 2. Furthermore, the work apparatus 1 comprises a drive motor 3 (FIG. 5), the drive motor 3 being arranged in the housing 2. In FIG. 1 is the drive motor 3 is shown merely schematically by way of a dashed square. In the present exemplary embodiment, the drive motor 3 is an electric motor. In an alternative embodiment, the drive motor 3 could also be an internal combustion engine. The drive motor 3 is used for driving a tool 5 to be arranged on the work apparatus 1. In the present exemplary embodiment, the tool 5 is a cutting wheel.

As shown in FIGS. 5 and 6, the work apparatus 1 comprises at least one battery pack 7 for supplying the drive motor 3 with electrical power. Particularly preferably, the work apparatus 1 comprises a further battery pack 7′ for supplying the drive motor 3 with power. A receptacle housing 20 is provided for accommodating the at least one battery pack 7 and/or the further battery pack 7′. The receptacle housing 20 is arranged on the housing 2, in particular fixed thereon. In the present embodiment of the work apparatus 1, the receptacle housing 20 is designed as a component that is separate from the housing 2. In an alternative embodiment, it can also be provided that the receptacle housing 20 and the housing 2 are designed as a single piece, in particular the receptacle housing 20 is an integral part of the housing 2. The receptacle housing 20 comprises a first receptacle 21 for receiving the at least one battery pack 7. Furthermore, the receptacle housing 20 comprises a second receptacle 22 for receiving the further battery pack 7′. The battery packs 7, 7′ can be removed from the receptacle housing 20, in particular the receptacles 21, 22, without using tools. To attach the battery packs 7, 7′ to the work apparatus 1, they are inserted into the receptacle housing 20, in particular into the receptacles 21, 22, and clipped into place. This clip attachment can be released without using tools and the battery packs 7, 7′ can be removed from the receptacle housing 20, in particular from the receptacles 21, 22, again, for example for charging or simply to replace them. The battery packs 7, 7′ can alternatively be designed as slide-in battery packs.

As shown in FIGS. 1 and 2, the work apparatus 1 comprises a rear handle 53. Furthermore, the work apparatus 1 comprises a front handle 54. The front handle 54 is preferably designed as a handle tube. Other configurations of the front handle 54 can also be expedient. The housing 2 extends from a rear end 35 up to a front end 36. The rear handle 53 forms in the present case the rear end 35 of the housing 2. In an alternative embodiment, it can also be provided that the rear handle 53 is designed to be separate from the housing 2. In such an embodiment, the rear handle 53 is arranged in the region of the rear end 35 of the housing 2. The front handle 54 is arranged in the region of the front end 36 of the housing 2.

In addition, the work apparatus 1 has a control element 6, the control element 6 being provided for controlling the drive motor 3. The control element 6 is designed as an operating lever. The control element 6 is assigned to the rear handle 53. Furthermore, the work apparatus 1 comprises a blocking element 9, which locks the control element 6 in a blocking position and releases the control element 6 for actuation in an enable position. The blocking element 9 is preferably designed as a blocking lever. The blocking as well as the enable function performed by the blocking element 9 can take e place mechanically and/or electronically, for example by means of sensors. The blocking element 9 is assigned to the rear handle 53. This means that when the operator grips the rear handle 53, they can actuate the control element 6 as well as the blocking element 9. In the preferred exemplary embodiment, the control element 6 and the blocking element 9 are arranged on the rear handle 53.

Particularly preferably, the work apparatus 1 comprises a control unit, not shown in more detail. The control unit processes signals that are generated by the control element 6 and/or the blocking element 9 and is mainly used for controlling the drive motor 3. Other functions of the work apparatus 1 can also be implemented via the control unit.

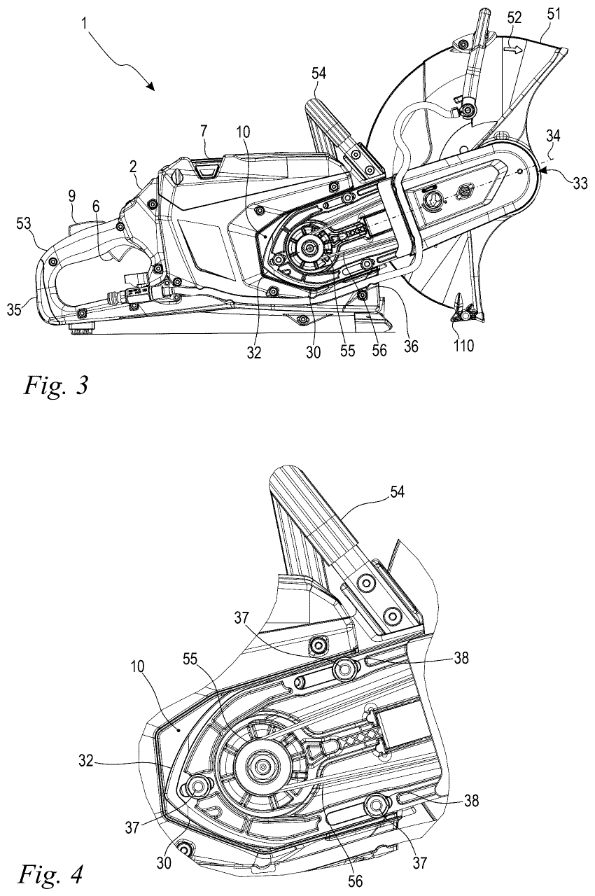

As shown in FIG. 3, the work apparatus 1 comprises an arm 30. The arm 30 extends along its longitudinal centre axis 34 from a proximal end 32 up to a distal end 33. The arm 30 is at least indirectly secured to the housing 2. The arm 30 is secured indirectly to the housing 2 in particular in the region of the front end 36 of the housing 2. The arm 30 protrudes beyond the front end 36 of the housing 2 and extends with its distal end 33 away from the front end 36 of the housing 2. The tool 5 can be arranged on the distal end 33 of the arm 30. The tool 5 is rotatably mounted on the distal end 33 of the arm 30. When the work apparatus 1 is in operation, the tool 5 is driven in rotation by the drive motor 3 in a direction of rotation 52 (FIGS. 1 and 3).

As shown in FIGS. 3 and 4, the work apparatus 1 comprises a pulley 55 that is driven via the drive motor 3. Furthermore, the work apparatus 1 comprises a further pulley (not shown in more detail) that is arranged at the distal end 33 of the arm 30 and is fixedly connected to the tool 5 in the direction of rotation 52 of the tool 5. Of course, the tool 5 as well as the further pulley can be detached, whereby they can each be replaced individually. The pulley 55, which is preferably arranged in the region of the proximal end 32 of the arm 30 on the housing 2, is operatively connected to the further pulley via a belt 56. The belt 56 is used for transmitting speed and torque between the drive motor 3 and the tool 5.

As shown in FIGS. 1 and 2, the work apparatus 1 comprises a protective hood 51. The protective hood 51 is attached to the arm 30, in particular to the distal end 33 of the arm 30. The protective hood 51 covers part of the circumference of the tool 5.

As shown in FIG. 2, the work apparatus 1 comprises a top side 44 and a bottom side 45, wherein the bottom side 45 of the work apparatus 1 can be set down on a floor 40. The top side 44 and the bottom side 45 are connected to one another by a first longitudinal outer side 46 and a second longitudinal outer side 47. Expressions which describe the sides or other components of the work apparatus 1 in terms of space, for example “top side” and “bottom side”, refer in principle in this case to the usual set-down position of the work apparatus 1 shown in FIG. 2. The usual set-down position of the work apparatus 1 is a position in which the work apparatus 1 is set down on a flat, horizontal set-down surface. Feet 57 are used for setting down the work apparatus 1.

As shown in FIGS. 5 to 7, the work apparatus 1 comprises a motor support unit 10. The motor support unit 10 is designed to be separate from the housing 2. The drive motor 3 is preferably attached to the motor support unit 10 directly. The housing 2 is likewise attached to the motor support unit 10.

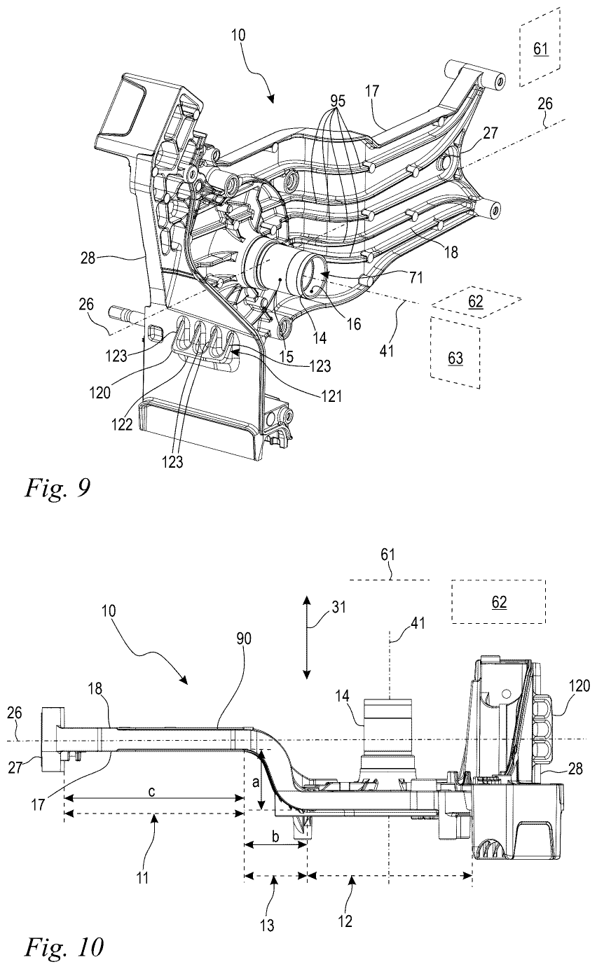

As shown in FIGS. 8 and 9, the motor support unit 10 is designed as a motor support plate. The motor support unit 10 has a longitudinal extent. The motor support unit 10 comprises a rear end 27 and a front end 28. The rear handle 53 is arranged on the rear end 27 of the motor support unit 10. The front handle 54 is arranged on the front end 28. The motor support unit 10 has a longitudinal centre axis 26 which extends from the rear end 27 of the motor support unit 10 up to the front end 28 of the motor support unit 10. The longitudinal centre axis 26 lies in a longitudinal plane 61 of the motor support unit 10. The longitudinal plane 61 is aligned parallel to the tool plane 50. In an alternative embodiment of the work apparatus 1 it can also be provided that the longitudinal plane 61 of the motor support unit 10 corresponds to the tool plane 50.

As shown in FIG. 9, the motor support unit 10 comprises a motor receptacle 14, which in the present embodiment is designed in particular as a hollow tube. The motor receptacle 14, in particular the hollow tube, has an outer side 15 and an inner side 16. The drive shaft 4 of the drive motor 3 is mounted in the hollow tube so as to rotate about an axis of rotation 41 (FIG. 5).

As shown in FIG. 5, comprises the drive motor 3 designed as an electric motor comprises a stator 42 and a rotor 43. The stator 42, which comprises a plurality of coils, is arranged on the outer side 15 of the hollow tube, in particular directly. The rotor 43 comprises in turn the drive shaft 4 and a rotor section 58 extending over the stator 42. The rotor section 58 is provided with corresponding permanent magnets which interact with the coils of the stator 42. The rotor section 58 and the drive shaft 4 are connected to one another in a rotationally fixed manner. The rotor 43 is mounted via its drive shaft 4 by means of two bearings 59, 59′ on the inner side 16 of the hollow tube such that it can rotate relative to the latter. The electric motor is designed in the present case as an outrunner. In an alternative embodiment of the work apparatus 1, it can also be expedient to design the electric motor as an inrunner.

As shown in FIG. 9, the axis of rotation 41 of the drive shaft 4 is aligned somewhat perpendicular to the longitudinal plane 61 of the motor support unit 10. The axis of rotation 41 lies within a vertical plane 63 of the motor support unit 10. The vertical plane 63 of the motor support unit 10 is aligned perpendicular to the longitudinal centre axis 26, in particular perpendicular to the longitudinal plane 61. Furthermore, the motor support unit 10 has a transverse plane 62 aligned perpendicular to the vertical plane 63 and perpendicular to the longitudinal plane 61.

As shown in FIGS. 8 and 10, the motor support unit 10 has a first longitudinal section 11, a second longitudinal section 12 and a middle section 13. The middle section 13 is provided between the first longitudinal section 11 and the second longitudinal section 12. The first longitudinal section 11 and the second longitudinal section 12 are preferably connected to one another via the middle section 13. The mentioned sections divide the motor support unit 10 in the direction of the longitudinal centre axis 26. The first longitudinal section 11 extends from the rear end 27 of the motor support unit 10 up to the middle section 13 of the motor support unit 10. The middle section 13 of the motor support unit 10 extends from the first longitudinal section 11 of the motor support unit 10 up to the second longitudinal section 12 of the motor support unit 10. The second longitudinal section 12 of the motor support unit 10 extends from the middle section 13 of the motor support unit 10 up to the front end 28 of the motor support unit 10.

As shown in particular in FIG. 10, is the middle section 13 is approximately Z-shaped in a plan view of the motor support unit 10, i.e. in a direction perpendicular to the transverse plane 62 of the motor support unit 10. The middle section 13 has a first curvature 91 and a second curvature 92, wherein the first curvature 91 and the second curvature 92 run in opposite directions to each other. Due to the arrangement of these two curvatures 91, 92 relative to each other, the middle section 13 has the approximately Z-shaped contour. The first curvature 91 has a first axis of curvature 93. The second curvature 92 has a second axis of curvature 94. The first axis of curvature 93 of the first curvature 91 and the second axis of curvature 94 of the second curvature 92 are aligned parallel to one another. The motor support unit 10 is thus only curved once. The first axis of curvature 93 of the first curvature 91 and the second axis of curvature 94 of the second curvature 92 are aligned perpendicular to the transverse plane 62.

The first longitudinal section 11 and the second longitudinal section 12 are aligned substantially parallel to one another. Due to the opposite curvatures 91, 92 of the middle section 13 of the motor support unit 10, the first longitudinal section 11 and the second longitudinal section 12 are arranged offset from one another in the direction perpendicular to the longitudinal plane 61 of the motor support unit 10. The motor support unit 10 has a first outer side 17 and a second outer side 18. The middle section 13 of the motor support unit 10 has an offset width a which is measured in the direction perpendicular to the longitudinal plane 61 of the motor support unit 10 on the first outer side 17 of the motor support unit 10. The offset width a corresponds to the maximum distance measured in the direction perpendicular to the longitudinal plane 61 between the respective transition regions of the middle section 13 and the first longitudinal section 11 and, respectively, second longitudinal section 12 on the first outer side 17. Furthermore, the middle section 13 of the motor support unit 10 has a length b, measured in the direction of the longitudinal centre axis 26, which corresponds to the distance between the first longitudinal section 11 and the second longitudinal section 12. The offset width a of the middle section 13 of the motor support unit 10 corresponds to at least 50%, preferably at least 70%, in particular at least 90% of the length b of the middle section 13 of the motor support unit 10. Furthermore, the first longitudinal section 11 has a length c, measured in the direction of the longitudinal centre axis 26, which corresponds to the distance between the rear end 27 and the middle section 13. The offset width a of the middle section 13 of the motor support unit 10 corresponds to at least 10%, in particular at least 20% of the length c of the first middle section 11 of the motor support unit 10.

As mentioned above, the motor support unit 10 is curved once. This configuration of the motor support unit 10 enables, in addition to the spatial designs in the housing interior, also the formation of a main demoulding direction 31. This also corresponds to the direction of the axis of rotation 41. This in turn enables the motor receptacle 14 to be configured in the form of a hollow tube. The housing interior is delimited by the housing 2. Components with a single curvature can be cast and demoulded significantly more easily than components with two curvatures. The tools required for this can have a simpler design.

As shown in FIGS. 6 and 8, the work apparatus 1 comprises first attachment units 65, which are provided for attaching the housing 2 to the motor support unit 10. Each first attachment unit 65 comprises a first fastener 66, designed in the present case as a screw, and a first attachment receptacle 67, which is designed as an opening with an internal thread for receiving the screw. At least one first attachment receptacle 67, in the present case four first attachment receptacles 67, is provided at the rear end 27 of the motor support unit 10 is. Furthermore, further first attachment receptacles 67 are provided in the middle section 13 of the motor support unit 10 and on the front end 28 of the motor support unit 10 for connecting the housing 2 to the motor support unit 10. At least one first attachment receptacle 67 is preferably also arranged on the second longitudinal section 12 of the motor support unit 10. By contrast, the first longitudinal section 11 of the motor support unit 10 is free of first attachment units 65, in particular of first attachment receptacles 67.

As shown in FIGS. 5 and 6, the drive motor 3 is attached in the second longitudinal section 12 of the motor support unit 10. The drive motor 3 is arranged substantially on the second outer side 18 of the motor support unit 10. The motor receptacle 14 is also provided on the second outer side 18 of the motor support unit 10.

As shown in particular in FIG. 8, the motor support unit 10 comprises an attaching section 19. The attaching section 19 is used for attaching a component to the motor support unit 10, with the tool 5 being held in turn on the component. In the present embodiment of the work apparatus 1, the attaching section is provided for attaching the arm 30 to the motor support unit 10. If the work apparatus 1 is a chainsaw, the attaching section 19 is preferably provided for attaching a guide bar thereto. The chainsaw chain would then be guided as a tool on the guide bar. The attaching section 19 is provided on the first outer side 17 of the arm 10. The attaching section 19 extends in the present exemplary embodiment from the middle section 13 via the second longitudinal section 12 up to the front end 28 of the motor support unit 10. In the region of the attaching section 19, multiple, in the present case three, stud bolts 37 are arranged on the motor support unit 10, in particular screwed into the motor support unit 10. The arm 10 rests, as shown in FIGS. 3 and 4, on the attaching section 19 of the motor support unit 10, and is fastened via the stud bolt 37 and the associated nuts 38 to the motor support unit 10. If the nuts 38 have been loosened, the arm 30 can be displaced in its longitudinal direction 34. The tension of the belt 56 can thus be adjusted. The stud bolts 38 attached in the motor support unit 10 pass through openings on the arm 30, which are designed as elongate holes so that the arm 30 can be displaced relative to the motor support unit 10.

Furthermore provided on the motor support unit 10 is a central opening 71 (FIGS. 8 and 9) which is part of the motor receptacle 14, in particular part of the hollow tube. The drive shaft 4 of the drive motor 3 projects through the central opening 71. The drive shaft 4 projects from the second outer side 18 of the motor support unit 10 through the central opening 71 onto the first outer side 17 of the motor support unit 10. Furthermore, the drive shaft 4 also projects through an opening in the arm 10. Arranged at the end of the drive shaft 4, which is located on the first outer side 17 of the motor support unit 10, is the pulley 55, which drives the belt 56. The arm 30 is covered by a cover 73. Moreover, the cover 73 also covers the pulley 55 as well as the belt 56.

As shown in FIG. 6, the housing 2 is attached to the rear end 27 of the motor support unit 10 by means of the attachment units 65. The housing 2 is formed from a handle housing 76 in this region. The handle housing 76 is attached via the attachment units 65 to the rear end 27 of the motor support unit 10. The rear handle 53 is provided on the handle housing 76. The actuating element 6 and the blocking element 9 are arranged on the rear handle 53.

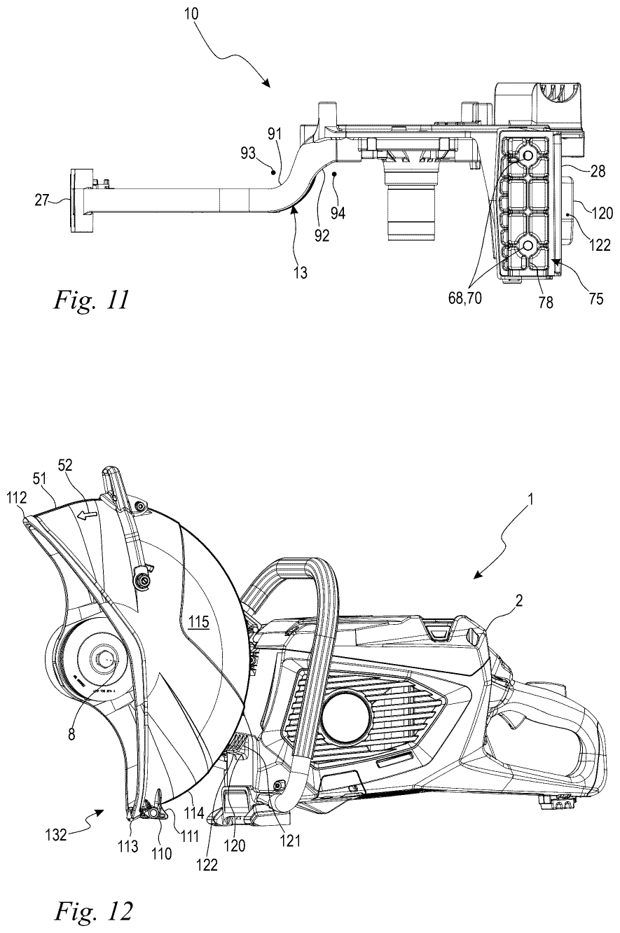

Second attachment units 68, in particular second attachment receptacles 70, are provided on the motor support unit 10 for attaching the front handle 54 to the motor support unit 10. As shown in particular in FIGS. 8 and 11, the second attachment units 68 are provided on the front end 28 of the motor support unit 10. Positioning the attachment units 68 at least partially differently, for example in the second longitudinal section 12 of the motor support unit 10, may also be expedient.

A first, upper handle receptacle 74 is arranged, in particular formed, on the motor support unit 10. The upper handle receptacle 74 is preferably an integral constituent part of the motor support unit 10. The first, upper handle receptacle 74 is used for mounting and attaching the front handle 54. The first, upper handle receptacle 74 of the motor support unit 10 is arranged in the region of the top side 44 of the work apparatus 1 as well as in the region of the first longitudinal outer side 46 of the work apparatus 1. The first, upper handle receptacle 74 has an approximately semi-cylindrical contour 77, in which the front handle 54 comes to rest. The front handle 54 is designed as a handle tube. Of course, the geometry of the handle tube as well as the contour 77 of the upper handle receptacle 74 are matched to each other. In the present exemplary embodiment, the handle tube is cylindrical and so the contour 77 is also semi-cylindrical. Other geometries of the handle tube as well as the contour 77 of the first, upper handle receptacle 74 can be expedient, provided these are matched to each other.

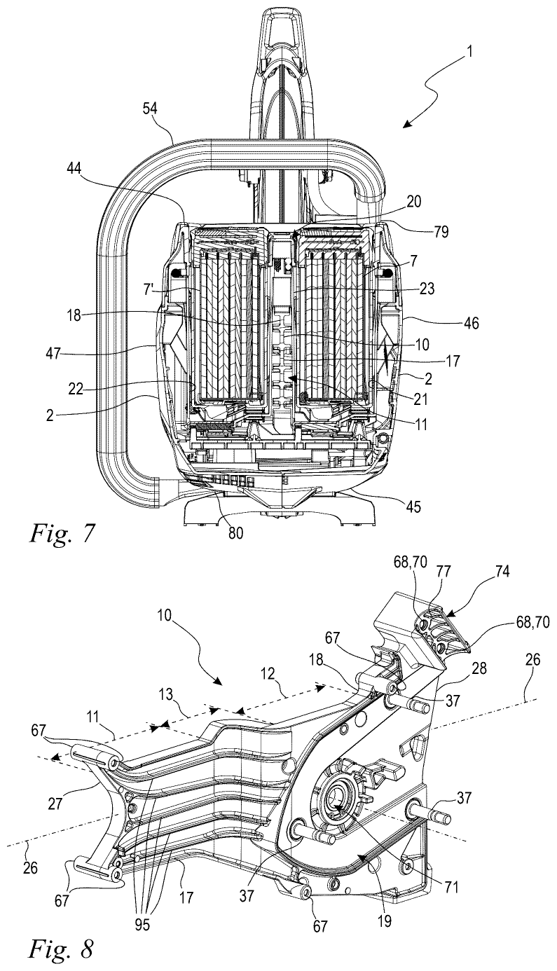

At least one second attachment receptacle 70, preferably two second attachment receptacles 70 are formed in the first, upper handle receptacle 74. The second attachment receptacles 70 are preferably formed as openings, each with an internal thread, whereby the front handle 54 can be screwed to the first, upper handle receptacle 74 using screws as fasteners 69. As shown in FIG. 7, the handle 54 extends from one end 79 to another end 80. Preferably, the one end 79 of the front handle 54 is attached to the first, upper handle receptacle 74 of the motor support unit 10.

A second, lower handle receptacle 75 is arranged, in particular formed, on the motor support unit 10 (FIG. 11). The second, lower handle receptacle 75 is preferably an integral part of the motor support unit 10. The second, lower handle receptacle 75 is used for mounting and attaching the front handle 54. The second, lower handle receptacle 75 of the motor support unit 10 is arranged in the region of the bottom side 45 of the work apparatus 1. Just like the first, upper handle receptacle 74, the second, lower handle receptacle 75 has an approximately semi-cylindrical contour 78, in which the front handle 54 comes to rest. At least one second attachment receptacle 70, preferably two second attachment receptacles 70, are formed in the second, lower handle receptacle 75. The front handle 54 can be screwed to the second, lower handle receptacle 75 using screws as fasteners 69. Preferably, the other end 80 of the front handle 54 is attached to the second, lower handle receptacle 75 of the motor support unit 10.

As shown in FIG. 7, the front handle 54, in particular the handle tube, runs from the first, upper handle receptacle 74 via the top side 44 to the second longitudinal outer side 47 of the work apparatus 1. From there, the front handle 54, in particular the handle tube, extends along the second longitudinal outer side 47 to the bottom side 45 of the work apparatus 1 and ends in the second, lower handle receptacle 75 on the bottom side 45 of the work apparatus 1. The front handle 54 is only attached to the motor support unit 10 via its two ends 79, 80. In the region between its two ends 79, 80, the front handle 54 is arranged spaced apart from the housing 2 of the work apparatus 1, so that the operator can grasp the front handle 54.

In an alternative embodiment of the work apparatus 1, it can also be provided that the first, upper handle receptacle 74 is arranged in a different place. For instance, the first, upper handle receptacle 74 can alternatively be integrated in the attaching section 19 of the motor support unit 10. In such an embodiment, the first, upper handle receptacle 74 would be arranged substantially on the first longitudinal outer side 46. Other positions are also conceivable. However, it is particularly advantageous that both the first, upper handle receptacle 74 and the second, lower handle receptacle 75 are formed directly on the motor support unit 10. The front handle 54 is thus attached directly to the motor support unit 10. The rear handle 53, in particular the handle housing 76, is also attached directly to the motor support unit 10. Particularly preferably, no separately formed antivibration element is provided between the front handle 54 and the motor support unit 10. Preferably, no separately formed antivibration element is provided between the rear handle 53 and the motor support unit 10 either. Since, in the present embodiment, the drive motor 3 is an electric motor, there is no need for vibration decoupling between the drive motor 3 and the front handle 54 as well as the rear handle 53.

As shown in FIGS. 5 to 7, the receptacle housing 20, in which the at least one battery pack 7 and/or the further battery pack 7′ are arranged, is arranged in the longitudinal section 11 of the motor support unit 10. The receptacle housing 20 thus lies, relative to the longitudinal direction 26 of the motor support unit 10, between the rear end 27 of the motor support unit 10 and the middle section 13 of the motor support unit 10. The first receptacle 21 of the receptacle housing 20 and the second receptacle 22 of the receptacle housing 20 are arranged separated from each other by the longitudinal section 11 of the motor support unit 10. In other words, the receptacle 21 and the receptacle 22 are arranged opposite each other in relation to the first longitudinal section 11 of the motor support unit 10. The first receptacle 21 of the receptacle housing 20 is arranged facing the first outer side 17 of the motor support unit 10, in particular in the first longitudinal section 11 of the motor support unit 10. The second receptacle 22 of the receptacle housing 20 is arranged facing the second outer side 18 of the motor support unit 10. The motor support unit 10 thus runs between the two receptacles 21, 22 of the receptacle housing 20, in particular between the two battery packs 7, 7′.

The receptacle housing 20, comprising the first receptacle 21 and the second receptacle 22, is preferably designed as a single piece. The receptacle housing 20 has an opening 23 which extends in the direction of the longitudinal centre axis 26 of the motor support unit 10. The motor support unit 10 can thus be arranged in the opening 23 of the receptacle housing 20. The opening 23 is open towards the bottom, i.e. towards the bottom side 45 of the work apparatus 1. The first receptacle 21 of the receptacle housing 20 and the second receptacle 22 of the receptacle housing 20 are separated from one another by the opening 23. Due to this arrangement of the motor support unit 10 and the receptacle housing 20, the motor support unit 10 is arranged at least partially centrally in the housing 2 of the work apparatus 1, whereby this evenly supports and braces the housing 2 via the first attachment units 65. Due to the arrangement of the two battery packs 7, 7′ and of the two receptacles 21, 22 of the receptacle housing 20 each on one outer side 17, 18 of the motor support unit 10, a compact design of the work apparatus 1 can simultaneously be ensured.

As shown in FIGS. 5 to 7, the receptacle housing 20 is only attached to the housing 2. By contrast, there is no direct attachment between the receptacle housing 20 and the motor support unit 10. The housing 2 has a certain degree of flexibility, which permits relative movement of the receptacle housing 20 with respect to the motor support unit 10. Moreover, the receptacle housing 20 and the motor support unit 10 arranged spaced apart from each other. This can ensure that in the event of a desired relative movement between the receptacle housing 20 and the motor support unit 10 mutual jamming of the components can be prevented. Particularly preferably, the motor support unit 10 is free of contact with respect to the receptacle housing 20 over its entire first longitudinal section 11. Third attachment units 82 are provided for attaching the receptacle housing 20 to the housing 2. The attachment units 82 are preferably formed from screw connections.

The motor support unit 10 is preferably a cast part. The motor support unit 10 is formed in particular from a material that has a higher modulus of elasticity than the material of the housing 2. The motor support unit 10 is preferably formed from a metal alloy, in particular from a magnesium alloy. The housing 2 is preferably formed from a plastic. The housing 2 is designed such that it has sufficient strength to protect the components arranged within the housing 2. At the same time, the housing 2 has an elasticity that absorbs corresponding inertial forces of the battery packs 7, 7′ in the event that the work apparatus 1 makes sudden impact with the ground or other objects, so that the forces transmitted from the receptacle housing 20 via the housing 2 to the motor support unit 20 are dampened accordingly.

The receptacle housing 20, the motor support unit 10 and the housing 2 are arranged and designed in relation to each other such that if the work apparatus 1 collides with an object or similar, a force, generated by the inertia of the battery packs 7, 7′ arranged in the receptacle housing 20 cannot flow directly from the receptacle housing 20 to the motor support unit 10. The force flows starting from the battery packs 7, 7′ via the receptacle housing 20 into the housing 2 and from the housing 2 into the motor support unit 10. As a result of elastic and/or plastic deformation of the housing 2, the energy is converted in the housing 2 by deformation. The resulting impact load acting on the motor support unit 10 is thus significantly reduced, whereby damage to the motor support unit 10 can be prevented.

As shown in FIG. 10, the motor support unit 10 comprises a base body 90, which extends from the first longitudinal section 11 via the middle section 13 up to and including the second longitudinal section 12. This base body 90 has a single curve made by the Z-shaped contour of the middle section 13. The motor receptacle 14 is arranged on the base body 90 of the motor support unit 10. The first longitudinal section 11 of the motor support unit 10 lies centrally in the housing interior (FIGS. 5 to 7). The rear handle 6 has a longitudinal centre axis 96, wherein, in a plan view of the work apparatus, i.e. when viewed in the direction of the transverse plane 62, the longitudinal centre axis 96 of the rear handle 6 lies in the first longitudinal section 11 of the motor support unit 10. As a result, the first longitudinal section 11 of the motor support unit 10 divides the housing interior in the region of the longitudinal section 11 into two equally sized smaller installation spaces, in each of which a receptacle 21, 22 of the receptacle housing 20 is arranged. The second longitudinal section 12 of the motor support unit 10 lies outside the longitudinal centre axis 96 of the rear handle 6. The distance between the second longitudinal section 12 of the motor support unit 10 and the first longitudinal outer side 46 of the work apparatus 1 is less than the distance between the first longitudinal section 11 of the motor support unit 10 and the first longitudinal outer side 46 of the work apparatus 1. As a result, the installation space in the region of the second longitudinal section 12 of the motor support unit 10 towards the second longitudinal outer side 47 is significantly bigger than the two smaller installations spaces in the region of the first longitudinal section 11 of the motor support unit 10.

As shown in FIGS. 8 and 9, the motor support unit 10 comprises at least one stiffening rib 95, in the present case multiple stiffening ribs 95. The stiffening ribs 95 run substantially in direction of the longitudinal centre axis 26 of the motor support unit 10. The stiffening ribs 95 are formed on both the first outer side 17 and on the second outer side 18. The stiffening ribs 95 run at least from the first longitudinal section 11 up to the middle section 13. In the present case, the stiffening ribs 95 run on the first outer side 17 of the motor support unit 10 from the rear end 27 of the motor support unit 10 over the first longitudinal section 1 of the motor support unit 10 and to the middle section 13 of the motor support unit 10. On the second outer side 18 of the motor support unit 10, the stiffening ribs 95 run from the rear end 27 of the motor support unit 10 over the first longitudinal section 11 of the motor support unit 10, over the middle section 13 of the motor support unit 10 and to the second longitudinal section 12 of the motor support unit 10. The stiffening ribs 95 are preferably free of interruption in the direction of the longitudinal centre axis 26 of the motor support unit 10.

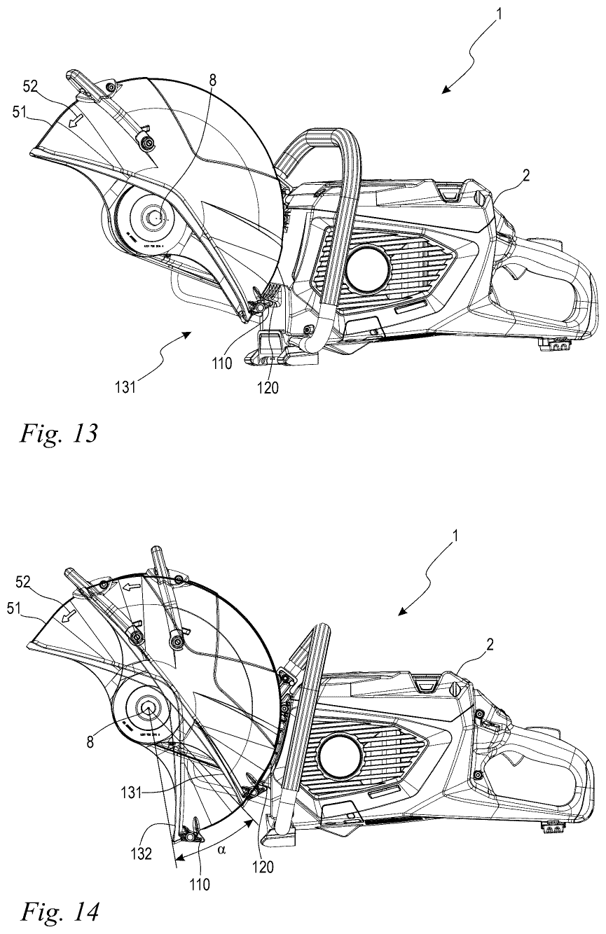

As shown in FIGS. 12 and 13, the work apparatus 1 comprises a stop 110. The stop 110 is arranged on the protective hood 51 of the work apparatus 1. Furthermore, the work apparatus 1 comprises a mating stop 120. The mating stop 120 is formed on the motor support unit 10. The stop 110 and the mating stop 120 are designed to interact mechanically in order to limit a pivoting movement of the protective hood 51 to an end position 131. The tool 5 is mounted so as to rotate about an axis of rotation 8. The protective hood 51 is mounted so as to pivot about an axis of rotation. The axis of rotation of the protective hood 51 corresponds to the axis of rotation 8 of the tool 5. The protective hood 51 can be pivoted from an open position 132, as is shown in FIG. 12, into the end position 131. In FIG. 13, the protective hood 51 of the work apparatus 1 is shown in the end position 131. The stop 110 of the protective hood 51 and the mating stop 120 of the motor support unit 10 make contact in this end position 131.

As shown in FIG. 14, the protective hood 51 is able to pivot about a maximum pivot angle α. The maximum pivot angle α extends, in relation to the axis of rotation 8, from the open position 132 into the end position 131. It is not possible for the protective hood 51 to pivot in the direction of rotation 52 of the tool 5 beyond the end position 131. It is not possible for the protective hood 51 to pivot counter to the direction of rotation 52 of the tool 5 beyond the open position 132. The maximum pivot angle α is preferably less than or equal to 90°, in particular less than 60°. The maximum pivot angle α of the protective hood 51 from the open position 132 to the end position 131 or from the end position 131 to the open position 132 is preferably at least 30°.

As shown in FIG. 12, the protective hood 51 extends from a first end 112 about the axis of rotation 8 up to a second end 113. The second end 113 is the end of the protective hood 51 which, both in the end position 131 and in the open position 132 of the protective hood 51, is arranged closer to the housing 2, preferably closer to the motor support unit 10. Moreover, the second end 113 lies below the first end 112 of the protective hood 51. The stop 110 is preferably arranged adjacent to the end 113 of the protective hood 51. The protective hood 51 has a first longitudinal side 115, a second longitudinal side 116 as well as a peripheral side 114. The first longitudinal side 115 and the second longitudinal side 116 are connected to one another via the peripheral side 114. The main direction of extension of the first longitudinal side 115 and the second longitudinal side 116 of the protective hood 51 runs approximately parallel to the tool plane 50. The stop 110 is arranged on the peripheral side 114 of the protective hood 51.

The stop 110 is preferably integral with the protective hood 51. The protective hood 51 is preferably a cast component. The protective hood 51 and the stop 110 are preferably formed from a single cast component. The protective hood 51 as well as the stop 110 are formed in particular from a metal alloy. Thus, the protective hood 51 together with the stop 110 has a high component strength. In an alternative embodiment, it can also be provided that the protective hood 51 is welded from sheet metal elements.

As shown in particular in FIGS. 9 to 11, the mating stop 120 is arranged on the front end 28 of the motor support unit 10. Particularly preferably, the mating stop 120 is integral with the motor support unit 10. As already mentioned above, the motor support unit 10 is designed in the preferred embodiment as a cast component. Therefore, the motor support unit 10 as well as the mating stop 120 form a single cast component. The motor support unit 10 as well as the mating stop 120 consist preferably of a metal alloy, in particular of a magnesium alloy.

As shown in FIGS. 12 to 16, the work apparatus 1 comprises a first stop surface 111 and a second stop surface 122. The first stop surface 111 is formed on the stop 110 of the protective hood 51. The second stop surface 122 is formed on the mating stop 120 of the motor support unit 10. In the end position 131 of the protective hood 51, the stop 110 lies with the first stop surface 111 on the second stop surface 122 of the mating stop 122. In the end stop 131 of the protective hood 51, the first stop surface 111 and the second stop surface 122 make contact with each other in a contact surface 130. The first stop surface 111 and the second stop surface 122 are therefore designed in such a way that they make full area contact with each other in the end position 131 of the protective hood 51.

FIG. 16 shows an enlarged view of the stop 110 and the mating stop 120 in mutual contact. The contact surface 130 spans a contact plane 140. The tool 5 is shown in FIG. 16 as a dashed line and has a tool circumference 141. The fact that such a tool 5, in the form, for example, of a cutting wheel, does not have an ideally circular tool circumference should be understood as meaning a, in relation to the axis of rotation 8 of the tool 5, radially outermost contour of a rotary body specified by the tool 5. The contact plane 140 intersects the tool 5 at the tool circumference 141 of the tool 5 at a contact line that is not shown in more detail. At this contact line, the tool 5 has a tangent plane 142. In other words, the tool 5 has a tangent plane 142 that is tangent to the tool 5 at the tool circumference 141 at the mentioned contact line. Contact plane 140 and tangent plane 142 intersect at the contact line, thereby making an angle β. The angle β is open in relation to the contact line in the direction of rotation 52 of the tool 5. The angle β is preferably less than 90°, in particular less than 80°. The angle β is in particular more than 60°, in particular more than 70°. The angle β is selected such that the stop and the mating stop hook into each other. The protective hood 51 is pulled towards the motor support unit 10 by the above-described angular alignment of the contact zone when stop 110 and end stop 120 come into contact. Nevertheless, the angle β is not so acute that the attraction forces of stop 110 and mating stop 120 are so high that the stop 110 breaks out of the protective hood 51 or the mating stop 120 breaks out of the motor support unit 10.

As shown in particular in FIG. 9, the mating stop 120 has a load transfer structure 121. The load transfer structure 121 extends starting from the second stop surface 122 tangentially to the direction of rotation 52 of the tool in the base body 90 of the motor support unit (FIG. 14). The mating stop 120 has multiple ribs 123 which are parts of the load transfer structure 121. In the preferred embodiment of the work apparatus 1, the mating stop 120 comprises two outer ribs 123 which limit the mating stop 120 in the direction of the axis of rotation 8 of the tool 5, i.e. in the width of the mating stop. Arranged between the two outer ribs 123 is at least one further rib, preferably two ribs or more. On the one hand this provides sufficient support structure that enables a high transmission of force from the stop 110 of the protective hood 51 via the mating stop 120 to the base body 90 of the motor support unit 10. On the other hand, the ribbed load transfer structure favours the manufacture of the mating stop 120 as a cast component.

As shown in FIG. 16, the first stop surface 111 on the stop 110 of the protective hood 51 is aligned in the direction of rotation 52 of the tool 5. The second stop surface 122 on the mating stop 120 of the motor support unit 10 is aligned counter to the direction of rotation 52 of the tool 5.

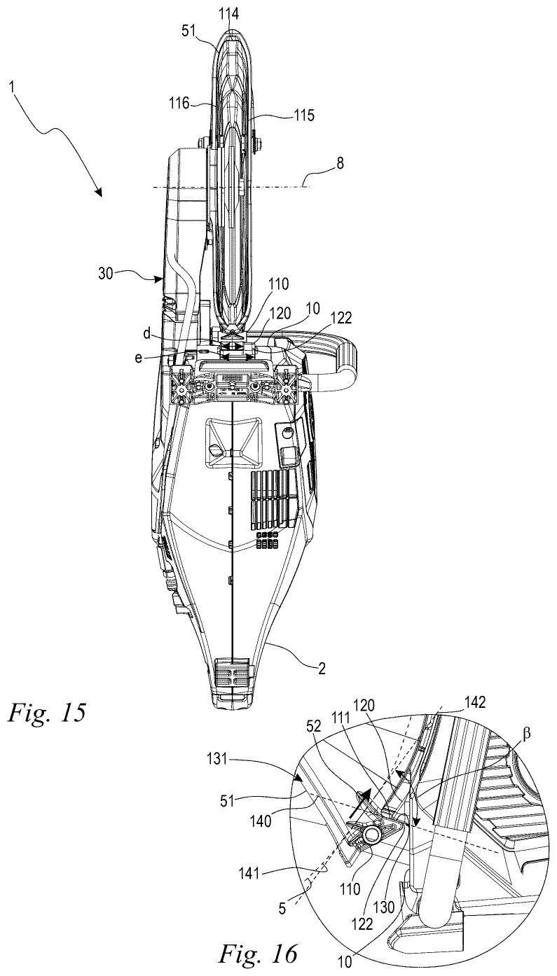

As shown in FIG. 15, the first stop surface 111 of the stop 110 has a width d measured in the direction of the axis of rotation 8 of the tool 5. The second stop surface 122 of the mating stop 120 has a width e measured in the direction of the axis of rotation 8 of the tool 5. The width e of the second stop surface 122 of the mating stop 120 is more than the width d of the first stop surface 111 of the stop 110. The width e of the second stop surface 122 of the mating stop 120 corresponds to at least 1.2 times, preferably at least 1.3 times, in particular at least 1.4 times the width d of the first stop surface 111 of the stop 110 of the protective hood 51. Particularly preferably, the width e of the second stop surface 122 of the mating stop 120 corresponds to approximately 1.5 times the width d of the first stop surface 111 of the stop 110 of the protective hood 51. The width d of the first stop surface 111 of the stop 110 is less than the width of the base body of the protective hood 51, which is specified by the distance, measured in the direction of the axis of rotation 8 of the tool 5, between the first longitudinal side 115 and the second longitudinal side 116 of the protective hood 51.

As shown in FIG. 15, the first stop surface 111 of the stop 110 and the second stop surface 122 of the mating stop 120 are arranged in relation to each other in such a way that their ends facing the arm 30 are arranged approximately in the same position arranged approximately in relation to a direction of the axis of rotation 8 of the tool 5. Since the second stop surface 122 is wider than the first stop surface 111, the end, facing away from the arm 30, of the second stop surface has a significantly greater distance from the arm than the end, facing away from the arm 30, of the first stop surface. It is thus ensured that even if the protective hood is deformed, for example by vibrations of the protective hood, the stop 110 with its entire first stop surface 111 comes to rest on the second stop surface 122 of the mating stop 120. If the protective hood 51 deforms, this is as a rule away from the arm 30, since this forms a single-sided stop for the protective hood 51.

In a further, alternative configuration of the work apparatus 1, provision is made, analogously to the shown embodiment, to also provide stops and counter-bodies, which make it possible to operate the work apparatus 1 with two directions of rotation of the tool 5.

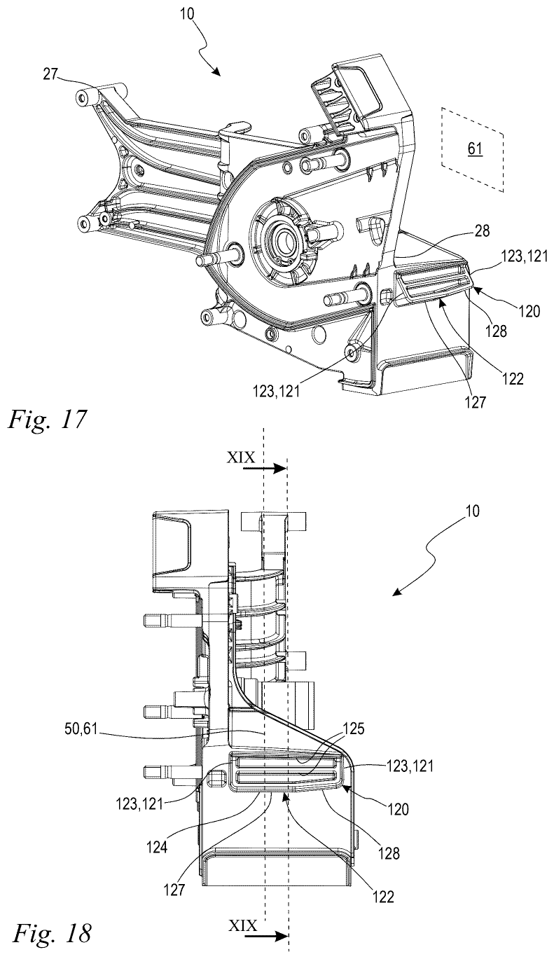

FIGS. 17 to 19 show a further embodiment of the motor support unit 10. The same reference signs designate the same components of the motor support unit 10. This motor support unit 10 essentially differs from the motor support unit according to FIG. 9 in the configuration of the mating stop 120. The mating stop 120 in this embodiment has two ribs 123, the main direction of extension of which runs in a plane that is aligned parallel to the longitudinal plane 61. These ribs 123 are referred to hereinafter as longitudinal ribs. In this embodiment, the two longitudinal ribs 123 are part of the load transfer structure 121.

As shown in FIGS. 17 and 18, the two longitudinal ribs 123 are designed as outer ribs and delimit the mating stop 120 in the direction of the axis of rotation 8 of the tool 5. Furthermore, the mating stop 120 comprises a first transverse rib 124 as well as at least one further transverse rib 125. In the present embodiment, two further transverse ribs 125 are provided on the mating stop 120. A different number of further transverse ribs can also be expedient. The multiple transverse ribs 124, 125 have a main direction of extension, which corresponds to the direction of the axis of rotation 8 of the tool 5. The second stop surface 122 of the mating stop 120 is formed on the first transverse rib 124. Since the two longitudinal ribs 123 are only arranged on the outer ends of the transverse ribs 124, 125, the strength of the mating stop in the middle area of the first transverse rib 124 is reduced. If, for example, when the tool 5 ruptures, the stop 110 hits the second stop surface 122 of the mating stop 120 with its first stop surface 111, the second stop surface may deform in the direction of loading due to the reduced strength owing to the lack of additional longitudinal ribs. In the process, the kinetic energy of the protective hood 51 is dissipated. If the high kinetic energy of the protective hood 51 is high, the stop surface 122 deforms in such a way that at least one further transverse rib 125 is contacted. If necessary, the one further transverse rib 125, in the present case the second transverse rib 125, is also correspondingly deformed, so that the stop 110 of the protective hood 51 collides with the third transverse rib 125. The work apparatus 1 is designed such that the stop 110 of the protective hood 51 reaches its end position 131 at least at the last, in the present case in particular to the third, transverse rib 125. During the deformation of the transverse ribs 124, 125, the kinetic energy of the protective hood 51 is gradually dissipated, whereby the maximum forces acting on the protective hood 51 are reduced.

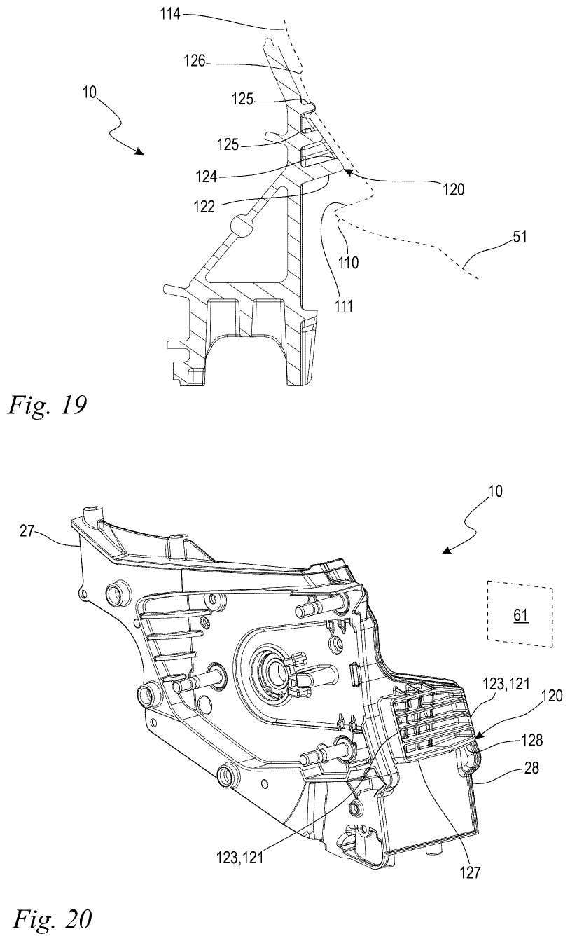

FIG. 19 shows the motor support unit 10 in a cutaway sectional illustration with the section line according to FIG. 18. The protective hood 51 with its stop 110 is schematically indicated using a dashed line. One of the transverse ribs 124, 125, in the present case the third transverse rib 125, is designed in such a way that if the tool 5 ruptures, said rib contacts the peripheral side 114 of the protective hood 51, even before the stop 110 of the protective hood 51 hits the mating stop 120 of the motor support unit 10. When the tool 5 ruptures, the protective hood 51 can elastically deform and deflect at the interface between the protective hood 51 and the arm 30. As a result, the peripheral side 114 contacts the corresponding transverse rib 125. This mean that energy is dissipated due to the contact between the peripheral side 114 of the protective hood 51 and the corresponding transverse rib 125 of the mating stop 120, even before the stop 110 of the protective hood 51 hits the mating stop 120 of the motor support unit 10. The collision energy of the two stops is thus reduced. The corresponding transverse rib 125, which is intended to contact the peripheral side 114 of the protective hood 51, has in the operating state, apart from when the tool 5 ruptures, a shorter distance to the peripheral side 114 of the protective hood 51 than the other transverse ribs 124, 125. It can alternatively also be provided that multiple transverse ribs 124, 125 are designed to make contact with the protective hood 51 on the peripheral side, in the event of the tool rupturing. In particular, a ridge 126 is formed on the protective hood 51, which ridge is provided as a projection on the peripheral side 114 of the protective hood 51. Thus, in the present embodiment, the ridge 126 of the protective hood 51 contacts the corresponding transverse rib 125 of the mating stop 120.

It is shown in FIGS. 17 and 18 that the second stop surface 122 divides the mating stop 120 into a main surface 127 and a secondary surface 128. The main surface 127 is aligned perpendicular to the tool plane 50 or perpendicular to the longitudinal plane 61 of the work apparatus 1. If the protective hood 51 rotates in the tool plane 50, the first stop surface 111 of the stop 110 of the protective hood 51 contacts the mating stop 120 in its main surface 127.

The secondary surface 128 of the second stop surface 122 directly adjoins the main surface 127 of the second stop surface 122. The main surface 127 is aligned in such a way that it is intersected by the tool plane 50. The secondary surface 128 of the second stop surface 122 lies outside the tool plane 50. However, the secondary surface 128 and the main surface 127 are not aligned parallel to one another. The secondary surface 128 has a slope with respect to the main surface 127. The slope is in the present embodiment approximately 5°. If the tool 5 ruptures, then the protective hood 51, as described above, can elastically deform and deflect at the interface to the arm 30. Typically, the protective hood 51 deforms in such a way that it deforms at its bottom side towards the first longitudinal side 115 and deforms at its top side towards the second longitudinal side 116. As a result, plane of rotation of the protective hood 51 pivots relative to the original tool plane 50, whereby the first stop surface 111 of the stop 110 and the main surface 127 of the second stop surface 122 of the mating stop 120 no longer make full area contact. In this deformed state, the first stop surface 111 of the stop 110 hits the secondary surface 128 of the second stop surface 122 of the mating stop 120. Due to the inclined alignment of the secondary surface 128, the secondary surface 128 and the first stop surface 111 of the stop 110 are in contact over as large an area as possible. This ensures the transmission of force over a large surface area.

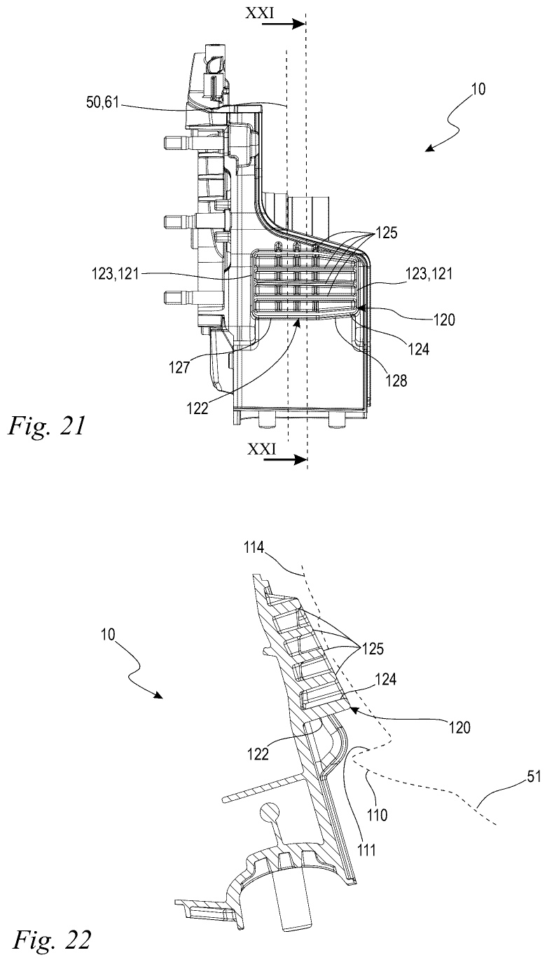

FIGS. 20 to 22 show an additional embodiment of the motor support unit 10. The same reference signs designate the same components of the motor support unit 10. The mating stop 120 comprises multiple transverse ribs 125 in addition to the first transverse rib 124. There are four multiple transverse ribs 125 in this exemplary embodiment. The kinetic energy of the protective hood 51 can thus be dissipated when the first transverse rib 124 as well as the multiple transverse ribs 125 deform.

A significant difference from the embodiment according to FIGS. 17 to 19 lies in the configuration of the longitudinal ribs 123, 129. The mating stop 120 comprises outer longitudinal ribs 123, which enclose the transverse ribs 124, 125 at their ends. Thus, the two outer longitudinal ribs 123 form a partial frame for the mating stop 120. Furthermore, the mating stop 120 comprises inner longitudinal ribs 129. In the present embodiment, the mating stop 120 comprises multiple inner longitudinal ribs 129, in particular three inner longitudinal ribs 129. A different number of inner longitudinal ribs 129 can also be expedient. The inner longitudinal ribs 129 extend, as do in particular the outer longitudinal ribs 123, from the first transverse rib 124 across all transverse ribs 125. The inner longitudinal ribs 129 have a height h, as shown in FIG. 22. The height h is measured orthogonal to the base of the mating stop 120 on which the inner longitudinal ribs 129 are arranged. The height h of each inner longitudinal rib 129 increase in particular linearly in its longitudinal direction starting from the first transverse rib 124 to the last transverse rib 125. Due to the increase in the height h of the inner longitudinal ribs 129 in their longitudinal direction, the distance between the inner longitudinal rib 129 and the protective hood 51 is also reduced. The inner longitudinal ribs 129 of the mating stop 120 are designed and arranged in such a way that the stop 110 subsequently contacts the inner longitudinal ribs 129 when the first transverse rib 124 deforms. The further the stop 110 turns into the mating stop 120, the greater the resistance by the inner longitudinal ribs 129 against the rotational movement of the protective hood 51. The inner longitudinal ribs 129 effect a type of wedge effect against the stop 110, which counteracts any further rotation of the protective hood 51. Thus, the kinetic energy of the protective hood 51 is dissipated via the stop 110 making contact with the transverse ribs 124, 125 of the mating stop 120 on the one hand and with the inner longitudinal ribs 129 of the mating stop 120 on the other hand.

The second stop surface 122 of the mating stop 120 is divided into a main surface 127 and a secondary surface 128, just like in the embodiments of the motor support unit according to FIG. 9 as well as according to FIGS. 17 to 19.

1.-10. (canceled)

11. A handheld work apparatus, comprising
a housing (2);
a motor support unit (10), the motor support unit (10) being separate from the housing (2) and connected to the housing (2);
a drive motor (3) arranged in the housing (2) for driving a tool (5) that rotates about an axis of rotation (8), the drive motor (3) being attached to the motor support unit (10);
a protective hood (51), the protective hood (51) at least partially covering the tool (5), with a stop (110) being provided on the protective hood (51); and
a mating stop (120) formed on the motor support unit (10), the mating stop (120) being provided for operative connection with the stop (110) of the protective hood (51) in order to restrict a pivoting movement of the protective hood (51) to an end position (131).

12. The handheld work apparatus according to claim 11,
wherein the protective hood (51) is mounted so as to pivot about the axis of rotation (8) of the tool (5), and
wherein a maximum pivot angle (α) of the protective hood (51), when pivoted from the end position (131) to an open position (132) of the protective hood (6), is less than or equal to 90°.

13. The handheld work apparatus according to claim 11,
wherein the protective hood (51) is mounted so as to pivot about the axis of rotation (8) of the tool (5), and
wherein a maximum pivot angle (α) of the protective hood (51) when pivoted from the end position (131) to an open position (132) of the protective hood (51) is at least 30°.

14. The handheld work apparatus according to claim 11,
wherein the mating stop (120) is integral with the motor support unit (10).

15. The handheld work apparatus according to claim 11,
wherein the motor support unit (10) is a cast component, and
wherein the motor support unit (10) consists of a magnesium alloy.

16. The handheld work apparatus according to claim 11,
wherein the mating stop (120) has a load transfer structure (121),
wherein the load transfer structure (121) extends starting from a stop surface (122) tangential to a direction of rotation (52) of the tool (5) into a base body (90) of the motor support unit (10).

17. The handheld work apparatus according to claim 11,
wherein the protective hood (51) consists of a metal alloy, and
wherein the stop (110) is cast onto the protective hood (51).

18. The handheld work apparatus according to claim 11,
wherein the handheld work apparatus (1) has a first stop surface (111) formed on the stop (110) of the protective hood (51),
wherein a stop surface (111) on the mating stop (120) is a second stop surface (122) of the handheld work apparatus (1), and
wherein, when the stop (110) and the mating stop (120) make contact, the first stop surface (111) and the second stop surface (122) touch each other in a common contact surface (130).

19. The handheld work apparatus according to claim 18,
wherein the common contact surface (130) spans a contact plane (140),
wherein the contact plane (140) intersects the tool (5) at a contact line on a tool circumference (141) of the tool (5) and makes an angle (β) with a tangent plane (142) of the tool (5) that touches the tool (5) at the contact line, and
wherein the angle (β) is open in a direction of rotation (52) of the tool (5), and
wherein the angle (β) is less than or equal to 90°.

20. The handheld work apparatus according to claim 18,
wherein in a direction of the axis of rotation (8) of the tool (5), the mating stop (120) is wider than the stop (110).

21. The handheld work apparatus according to claim 11,
wherein the mating stop (120) is formed directly on the motor support unit (10).
